(19) United States
(12) Patent Application Publication
(10) Pub. No.: US 2026/0343364 A1
(43) Pub. Date: Oct. 29, 2026

(54) WIRELESS COMMUNICATION SYSTEM, CENTRALIZED STATION, WIRELESS COMMUNICATION METHOD AND CENTRALIZED CONTROL PROGRAM

(71) Applicants: NTT, Inc., Tokyo (JP); NTT DOCOMO, INC., Tokyo (JP)

(72) Inventors: Hayato FUKUZONO, Musashino-shi, Tokyo (JP); Toshifumi MIYAGI, Musashino-shi, Tokyo (JP); Takeshi ONIZAWA, Musashino-shi, Tokyo (JP); Tatsuki OKUYAMA, Tokyo (JP); Satoshi SUYAMA, Tokyo (JP); Yoshihisa KISHIYAMA, Tokyo (JP)

(73) Assignees: NTT, Inc., Tokyo (JP); NTT DOCOMO, INC., Tokyo (JP)

(21) Appl. No.: 19/114,485

(22) PCT Filed: Sep. 27, 2022
(86) PCT No.: PCT/JP2022/035966

§ 371 Date: Mar. 24, 2025

(51) Int. Cl. H04W 36/30; H04W 36/32

(52) U.S. Cl. CPC H04W 36/304; H04W 36/322

(57) ABSTRACT

A wireless communication system according to one embodiment: selects the base station to be connected based on traffic of each terminal; continuously collects terminal position information of each terminal and propagation loss information between each terminal and each base station, respectively; calculates a packet error rate of each selected base station based on each collected piece of the terminal position information and the propagation loss information; determines, based on the calculated packet error rate, a presence or absence of the terminal of which communication quality with respect to the base station is below a predetermined value; and when it is determined that there is the terminal below the predetermined value, changes the base station to which the terminal is to be connected so that the communication quality of the connection of each terminal to the base station exceeds the predetermined value.

### TECHNICAL FIELD

The present invention relates to a wireless communication system, a centralized station, a wireless communication method, and a centralized control program.

### BACKGROUND ART

Conventionally, techniques have been studied for performing information communication in an efficient manner by applying algorithms similar to PageRank to the relevance of each user in SNSs (social networking services) and utilizing graph theory, big data analysis, and the like (for example, refer to NPL 1) .

For example, it is being considered to predict traffic of each base station (existing in cyberspace) of a CPS (cyber physical system) and feed the prediction back to the real world to use as a guide for selecting a base station for each user terminal.

In addition, for example, methods to improve efficiency of power used in wireless communication systems using an energy harvesting technique are being considered (for example, refer to NPL 2).

### CITATION LIST

### Non Patent Literature

[NPL 1] F. Amin, et al., “Hotspots Analysis Using Cyber-Physical-Social System for a Smart City,” IEEE Access VOLUME 8, 2020p.122197-122209
[NPL 2] J. Rubio and A. P. Iserte, “User grouping and resource allocation in multiuser MIMO systems under SWIPT,” EURASIP Journal on Wireless Communications and Networking 2019.

### SUMMARY OF THE INVENTION

### Problem to be Solved by the Invention

However, conventionally, due to an actual wireless situation of each terminal not being reflected and accuracy of selecting a base station to which each terminal is to be connected being low, a predetermined communication quality was prevented from being attained.

The present invention has been made in consideration of the problem described above and an object of the present invention is to provide a wireless communication system, a centralized station, a wireless communication method, and a centralized control program that enable optimization and selection of a base station to which each terminal is to be connected from among a plurality of base stations while maintaining a predetermined communication quality.

### Solution to Problem

A wireless communication system according to one embodiment of the present invention is a wireless communication system comprising a plurality of centralized stations that coordinate and centrally control a plurality of base stations that can each accommodate a plurality of terminals, wherein each centralized station includes: a selecting unit which predicts traffic between each of the terminals and each of the base stations based on a relevance of each user using each of the terminals and which selects the base station to be connected based on the traffic of each of the terminals; a collecting unit which continuously collects terminal position information indicating a position of each of the terminals and propagation loss information indicating propagation loss between each of the terminals and each of the base stations, respectively; a calculating unit which calculates a packet error rate of each of the base stations selected by the selecting unit based on each piece of the terminal position information and the propagation loss information continuously collected by the collecting unit; a determining unit which determines, based on the packet error rate calculated by the calculating unit, a presence or absence of the terminal of which communication quality with respect to the base station is below a predetermined value; and a changing unit which, when the determining unit determines that there is the terminal of which communication quality with respect to the base station is below a predetermined value, changes the base station to which the terminal is to be connected so that the communication quality of the connection of each terminal to the base station exceeds the predetermined value.

A centralized station according to one embodiment of the present invention is a centralized station which coordinates and centrally controls a plurality of base stations that can each accommodate a plurality of terminals, the centralized station comprising: a selecting unit which predicts traffic between each of the terminals and each of the base stations based on a relevance of each user using each of the terminals and which selects the base station to be connected based on the traffic of each of the terminals; a collecting unit which continuously collects terminal position information indicating a position of each of the terminals and propagation loss information indicating propagation loss between each of the terminals and each of the base stations, respectively; a calculating unit which calculates a packet error rate of each of the base stations selected by the selecting unit based on each piece of the terminal position information and the propagation loss information continuously collected by the collecting unit; a determining unit which determines, based on the packet error rate calculated by the calculating unit, a presence or absence of the terminal of which communication quality with respect to the base station is below a predetermined value; and a changing unit which, when the determining unit determines that there is the terminal of which communication quality with respect to the base station is below a predetermined value, changes the base station to which the terminal is to be connected so that the communication quality of the connection of each terminal to the base station exceeds the predetermined value.

A wireless communication method according to an embodiment of the present invention is a wireless communication method in which a plurality of centralized stations coordinate and centrally control a plurality of base stations that can each accommodate a plurality of terminals, the wireless communication method comprising: a selection step of predicting traffic between each of the terminals and each of the base stations based on a relevance of each user using each of the terminals and selecting the base station to be connected based on the traffic of each of the terminals; a collection step of continuously collecting terminal position information indicating a position of each of the terminals and propagation loss information indicating propagation loss between each of the terminals and each of the base stations, respectively; a calculation step of calculating a packet error rate of each of the base stations selected in the selection step based on each piece of the terminal position information and the propagation loss information continuously collected in the collection step; a determination step of determining, based on the packet error rate calculated in the calculation step, a presence or absence of the terminal of which communication quality with respect to the base station is below a predetermined value; and a changing step in which, when it is determined in the determination step that there is the terminal of which communication quality with respect to the base station is below a predetermined value, the base station to which the terminal is to be connected is changed so that the communication quality of the connection of each terminal to the base station exceeds the predetermined value.

### Advantageous Effect of the Invention

The present invention enables optimization and selection of a base station to which each terminal is to be connected from among a plurality of base stations while maintaining a predetermined communication quality.

### BRIEF DESCRIPTION OF DRAWINGS

FIG. 1 is a diagram showing an outline of a wireless communication system according to the embodiment.

FIG. 2 is a functional block diagram illustrating functions of the terminal.

FIG. 3 is a functional block diagram illustrating functions of the base station.

FIG. 4 is a functional block diagram illustrating functions of the centralized station.

FIG. 5 is a flow chart showing an operation example of the centralized station.

FIG. 6 is a diagram showing a configuration example of hardware included in each of the centralized stations according to the embodiment.

### DESCRIPTION OF EMBODIMENT

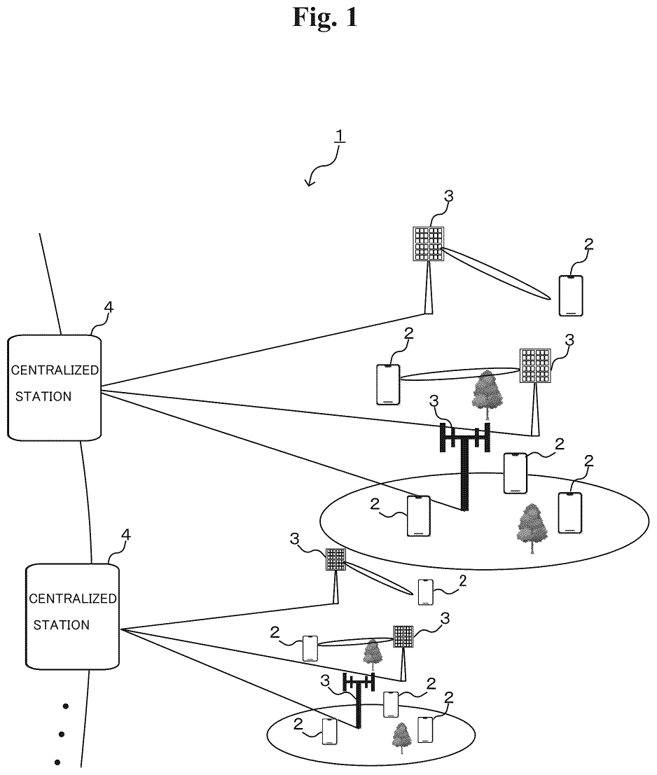

Hereinafter, a wireless communication system according to one embodiment will be described with reference to the drawings. FIG. 1 is a diagram showing an outline of a wireless communication system 1 according to the embodiment. As shown in FIG. 1, the wireless communication system 1 according to the embodiment includes a plurality of centralized stations 4 that coordinate and centrally control a plurality of base stations 3 that can each accommodate a plurality of terminals 2.

Each terminal 2 is a wireless terminal that a user uses for wireless communication. Each base station 3 may be a reflector plate that relays radio waves. Each centralized station 4 is configured to centrally control the plurality of base stations 3 in cooperation with other centralized stations 4.

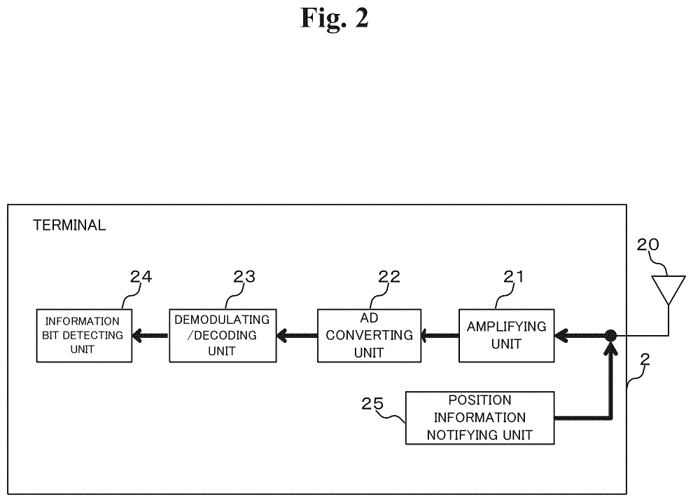

Next, functions of each of the terminals 2, the base stations 3, and the centralized stations 4 will be described in detail using FIGS. 2 to 4.

FIG. 2 is a functional block diagram illustrating functions of the terminal 2. As shown in FIG. 2, for example, the terminal 2 includes an antenna 20, an amplifying unit 21, an AD converting unit 22, a demodulating/decoding unit 23, an information bit detecting unit 24, and a position information notifying unit 25.

The amplifying unit 21 amplifies a signal received via the antenna 20 and outputs the amplified signal to the AD converting unit 22. Note that a converting unit or the like that converts frequencies may be provided in a stage preceding the amplifying unit 21.

The AD converting unit 22 is an analog-digital converting unit that converts an analog signal amplified by the amplifying unit 21 into a digital signal.

The demodulating/decoding unit 23 demodulates reception data having been converted into a digital signal by the AD converting unit 22, performs error correction decoding, and outputs the resultant signal to the information bit detecting unit 24.

The information bit detecting unit 24 detects an information bit from the signal inputted from the demodulating/decoding unit 23.

The position information notifying unit 25 generates a notification signal for notifying the base station 3 of information (terminal position information) indicating a position of its own station (the terminal 2) and notifies the base station 3 of the generated notification signal via the antenna 20.

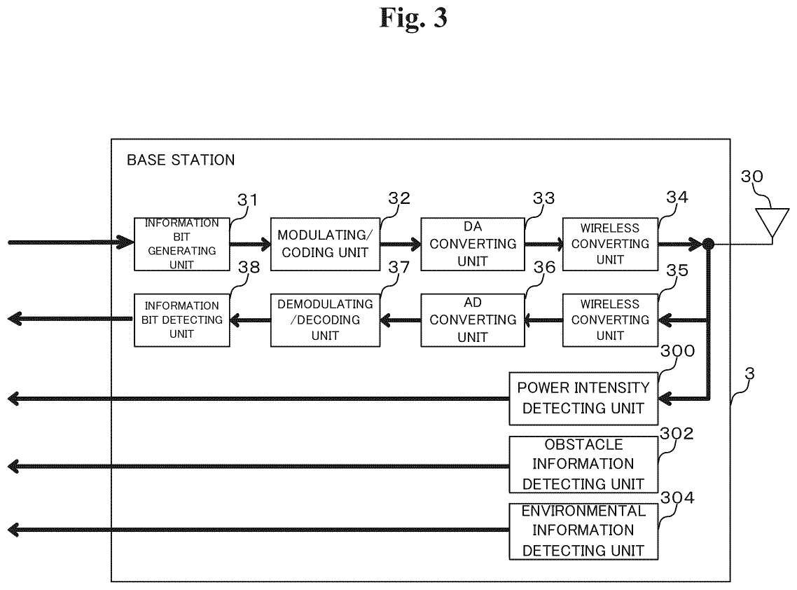

FIG. 3 is a functional block diagram illustrating functions of the base station 3. As shown in FIG. 3, for example, the base station 3 includes an antenna 30, an information bit generating unit 31, a modulating/coding unit 32, a DA converting unit 33, a wireless converting unit 34, a wireless converting unit 35, an AD converting unit 36, a demodulating/decoding unit 37, an information bit detecting unit 38, a power intensity detecting unit 300, an obstacle information detecting unit 302, and an environmental information detecting unit 304.

The information bit generating unit 31 generates an information bit indicating data and the like to be transmitted to the terminal 2 and outputs the generated information bit to the modulating/coding unit 32.

The modulating/coding unit 32 subjects the information bit generated by the information bit generating unit 31 to error correction coding, digitally modulates the information bit into a data signal, and outputs the data signal to the DA converting unit 33.

The DA converting unit 33 converts the data signal having been digitally-modulated by the modulating/coding unit 32 into an analog signal and outputs the analog signal to the wireless converting unit 34.

The wireless converting unit 34 converts the analog signal converted by the DA converting unit 33 into a predetermined wireless signal and transmits the wireless signal via the antenna 30.

The wireless converting unit 35 converts the wireless signal received via the antenna 30 into an analog signal with a predetermined frequency and outputs the analog signal to the AD converting unit 36.

The AD converting unit 36 is an analog-digital converting unit that converts the analog signal converted by the wireless converting unit 35 into a digital signal.

The demodulating/decoding unit 37 demodulates reception data having been converted into a digital signal by the AD converting unit 36, performs error correction decoding, and outputs the resultant signal to the information bit detecting unit 38.

The information bit detecting unit 38 detects an information bit from the signal inputted from the demodulating/decoding unit 37.

The power intensity detecting unit 300 performs processing of detecting intensity of power of a signal received from each terminal 2 via the antenna 30 and notifying the centralized station 4 of the intensity. For example, the power intensity detecting unit 300 detects a gain of each multipath for each delay time. In addition, the power intensity detecting unit 300 may have a function of detecting a distance to and from the terminal 2, a propagation loss to and from the terminal 2, and the like.

The obstacle information detecting unit 302 is an image sensor such as a CMOS sensor that detects an obstacle that affects communication with the terminal 2 and performs processing of notifying the centralized station 4 of information indicating the detected obstacle. For example, the obstacle information detecting unit 302 photographs an object positioned between each terminal 2 and itself.

The environmental information detecting unit 304 performs processing of detecting a peripheral environment that affects communication with the terminal 2 and notifying the centralized station 4 of environmental information indicating the detected peripheral environment.

In addition, for example, the base station 3 is configured to have a function of transmitting, to the centralized station 4, a wireless quality status (propagation loss, fading environment, or shadowing) between the terminal 2 and the base station 3, terminal position information indicating a position of the terminal 2 having been notified by the terminal 2, and the like.

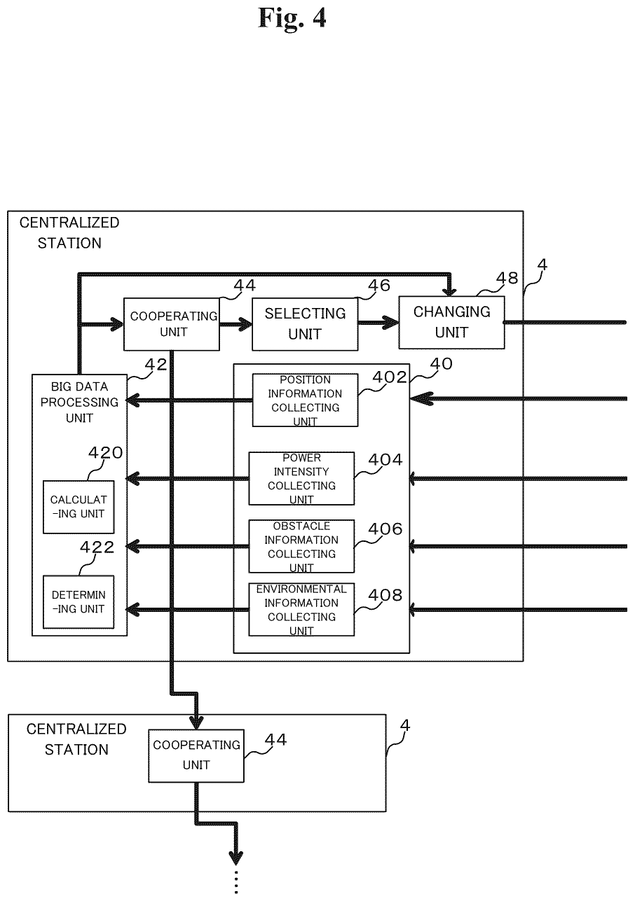

FIG. 4 is a functional block diagram illustrating functions of the centralized station 4. Since the centralized station 4 is configured to have a function of cooperating with other centralized stations 4, FIG. 4 also shows other centralized stations 4 in a simplified manner.

As shown in FIG. 4, for example, the centralized station 4 includes a collecting unit 40, a big data processing unit 42, a cooperating unit 44, a selecting unit 46, and a changing unit 48.

For example, the collecting unit 40 includes a position information collecting unit 402, a power intensity collecting unit 404, an obstacle information collecting unit 406, and an environmental information collecting unit 408, continuously collects terminal position information indicating a position of each of the terminals 2 and propagation loss information indicating propagation loss between each of the terminals 2 and each of the base stations 3, respectively, and outputs the collected information to the big data processing unit 42.

For example, the position information collecting unit 402 collects terminal position information indicating a position of each terminal 2 that is transmitted from the base station 3 and outputs the terminal position information to the big data processing unit 42.

The power intensity collecting unit 404 collects power information indicating an intensity of received power from each terminal 2 that is transmitted from the base station 3 and outputs the power information to the big data processing unit 42.

The obstacle information collecting unit 406 collects information indicating an obstacle that affects communication with the terminal 2 that is transmitted from the base station 3 and outputs the information to the big data processing unit 42.

The environmental information collecting unit 408 collects environmental information indicating a peripheral environment that affects communication with the terminal 2 that is transmitted from the base station 3 and outputs the information to the big data processing unit 42.

In other words, the collecting unit 40 has a function of collecting terminal position information and propagation loss information calculated based on an intensity of power detected by the power intensity detecting unit 300 and an object photographed by the obstacle information detecting unit 302 of the base station 3.

The big data processing unit 42 performs processing of generating a set of big data of the CPS described earlier and controlling the cooperating unit 44 and the changing unit 48 by being equipped with a calculating unit 420 and a determining unit 422.

For example, the calculating unit 420 calculates a packet error rate of each of the base stations 3 once selected by the selecting unit 46 as described later based on each piece of the terminal position information and the propagation loss information continuously collected by the collecting unit 40 and outputs the packet error rate to the determining unit 422.

Based on the packet error rate calculated by the calculating unit 420, the determining unit 422 determines a presence or absence of terminals 2 of which a communication quality with respect to the base station 3 is below a predetermined value.

The cooperating unit 44 cooperates with other centralized stations 4 to share a result of the processing by the big data processing unit 42 with the other centralized stations 4 and to output the result to the selecting unit 46.

The selecting unit 46 performs processing of selecting the base station 3 to which the terminal 2 is to be connected based on the result of the processing by the big data processing unit 42 and outputs a processing result to the changing unit 48. For example, the selecting unit 46 predicts the traffic between each of the terminals 2 and each of the base stations 3 based on a relevance of each of the users using the terminal 2, and selects the base station 3 to be connected based on the traffic of each of the terminals 2.

When the determining unit 422 determines that there is a terminal 2 of which communication quality with respect to the base station 3 is below a predetermined value, the changing unit 48 controls the base station 3 in order to change the base station 3 to which the terminal 2 is to be connected so that the communication quality of the connection of each terminal 2 to the base station 3 exceeds the predetermined value.

In addition, the centralized station 4 is configured to generate a set of big data using terminal position information indicating the position of each terminal collected via the base station 3 and actual data related to propagation loss (a distance between the terminal 2 and the base station 3, shadowing due to obstacles, and the like) and, together with the big data of CPS described earlier, to accurately select the base station 3 to which the terminal 2 is to be connected.

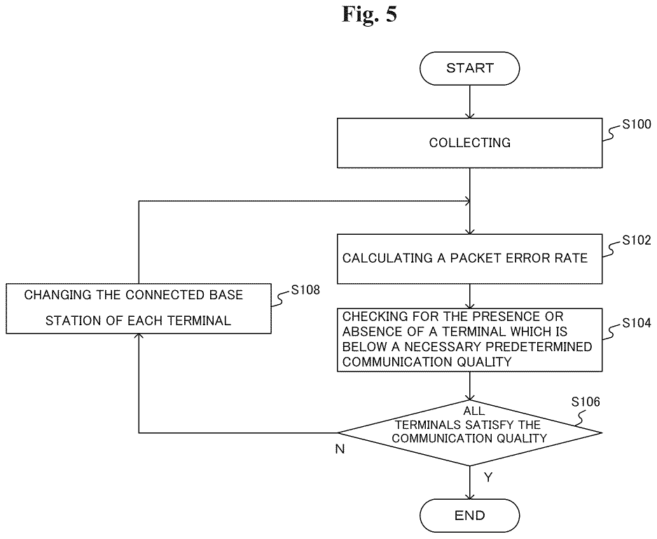

Next, an operation example of the centralized station 4 will be described. FIG. 5 is a flow chart showing an operation example of the centralized station 4. As shown in FIG. 5, for example, the centralized station 4 collects terminal position information and actual data related to propagation loss of each terminal 2 (S100).

Next, the centralized station 4 calculates a wireless packet error rate with respect to the base station selected using the big data of CPS (S102).

In addition, the centralized station 4 checks for the presence or absence of a terminal 2 of which an amount of traffic with respect to each packet error rate has declined and which is below a necessary predetermined communication quality (S104).

The centralized station 4 determines whether or not all terminals satisfy the necessary predetermined communication quality (S106) and, when all terminals satisfy the communication quality (S106: Yes), the centralized station 4 ends processing but, otherwise (S106: No), the centralized station 4 advances to the processing of S108.

In the processing of S108, the centralized station 4 performs processing of changing the connected base station of each terminal 2 and returns to the processing of S102.

As described above, since the wireless communication system 1 according to one embodiment continuously collects terminal position information of each of the terminals 2 and propagation loss information indicating propagation loss between each of the terminals 2 and each of the base stations 3 and, when there is a terminal 2 of which the communication quality with respect to the base station 3 is below a predetermined value, changes the base station 3 to which the terminal 2 is to be connected so that the communication quality exceeds the predetermined value, the base station 3 to which each terminal 2 is to be connected can be optimally selected from a plurality of base stations 3 while maintaining the predetermined communication quality.

Note that each function of the terminals 2, the base stations 3, and the centralized stations 4 may be partially or entirely constituted of hardware such as a PLD (Programmable Logic Device) or an FPGA (Field Programmable Gate Array) or configured as a program to be executed by a processor such as a CPU.

For example, the centralized stations 4 can be realized using a computer and a program and the program can be either recorded in a storage medium or provided through a network.

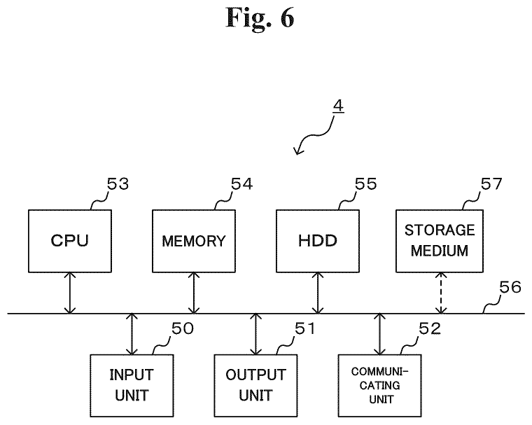

FIG. 6 is a diagram showing a configuration example of hardware included in each of the centralized stations 4 according to the embodiment. As shown in FIG. 6, in the centralized station 4, an input unit 50, an output unit 51, a communicating unit 52, a CPU 53, a memory 54, and an HDD 55 are connected via bus 56 and the centralized station 4 functions as a computer. In addition, the centralized station 4 is configured to be capable of inputting and outputting data to and from a computer-readable storage medium 57.

The input unit 50 is, for example, a keyboard and a mouse or the like. The output unit 51 is, for example, a display apparatus such as a display. In addition, the input unit 50 and the output unit 51 may be a touch panel or the like.

The communicating unit 52 is, for example, a communication interface that performs wireless communication.

The CPU 53 controls the various units that constitute the centralized station 4 and performs predetermined processing and the like. The memory 54 and the HDD 55 store data and the like.

The storage medium 57 is configured to be capable of storing a program and the like that causes functions of the centralized station 4 to be executed. Note that an architecture constituting the centralized station 4 is not limited to the example shown in FIG. 6.

### REFERENCE SIGNS LIST

1 Wireless communication system
2 Terminal
3 Base station
4 Centralized station
20 Antenna
21 Amplifying unit
22 AD converting unit
23 Demodulating/decoding unit
24 Information bit detecting unit
25 Position information notifying unit
30 Antenna
31 Information bit generating unit
32 Modulating/coding unit
33 DA converting unit
34 Wireless converting unit
35 Wireless converting unit
36 AD converting unit
37 Demodulating/decoding unit
38 Information bit detecting unit
40 Collecting unit
42 Big data processing unit
44 Cooperating unit
46 Selecting unit
48 Changing unit
50 Input unit
51 Output unit
52 Communicating unit
53 CPU
54 Memory
55 HDD
56 Bus
57 Storage medium
300 Power intensity detecting unit
302 Obstacle information detecting unit
304 Environmental information detecting unit
402 Position information collecting unit
404 Power intensity collecting unit
406 Obstacle information collecting unit
408 Environmental information collecting unit
420 Calculating unit
422 Determining unit

1. A wireless communication system comprising a plurality of centralized stations that coordinate and centrally control a plurality of base stations that can each accommodate a plurality of terminals, wherein
each centralized station includes:
selecting circuitry which predict traffic between each of the terminals and each of the base stations based on a relevance of each user using each of the terminals and which select the base station to be connected based on the traffic of each of the terminals;
collecting circuitry which continuously collect terminal position information indicating a position of each of the terminals and propagation loss information indicating propagation loss between each of the terminals and each of the base stations, respectively;
calculating circuitry which calculate a packet error rate of each of the base stations selected by the selecting circuitry based on each piece of the terminal position information and the propagation loss information continuously collected by the collecting circuitry;
determining circuitry which determine, based on the packet error rate calculated by the calculating circuitry, a presence or absence of the terminal of which communication quality with respect to the base station is below a predetermined value; and
changing unit circuitry which, when the determining circuitry determine that there is the terminal of which communication quality with respect to the base station is below a predetermined value, change the base station to which the terminal is to be connected so that the communication quality of the connection of each terminal to the base station exceeds the predetermined value.

2. The wireless communication system according to claim 1, wherein
each base station includes:
power intensity detecting circuitry which detect intensity of power received from each of the terminals; and
an image sensor which photographs an object positioned between each terminal and the base terminal, and
the collecting circuitry is configured to
collect terminal position information and propagation loss information calculated based on the intensity of power detected by the power intensity detecting circuitry and the object photographed by the image sensor.

3. A centralized station which coordinates and centrally controls a plurality of base stations that can each accommodate a plurality of terminals, the centralized station comprising:
selecting circuitry which predict traffic between each of the terminals and each of the base stations based on a relevance of each user using each of the terminals and which select the base station to be connected based on the traffic of each of the terminals;
collecting circuitry which continuously collect terminal position information indicating a position of each of the terminals and propagation loss information indicating propagation loss between each of the terminals and each of the base stations, respectively;
calculating circuitry which calculate a packet error rate of each of the base stations selected by the selecting circuitry based on each piece of the terminal position information and the propagation loss information continuously collected by the collecting circuitry;
determining circuitry which determine, based on the packet error rate calculated by the calculating circuitry, a presence or absence of the terminal of which communication quality with respect to the base station is below a predetermined value; and
changing circuitry which, when the determining circuitry determine that there is the terminal of which communication quality with respect to the base station is below a predetermined value, change the base station to which the terminal is to be connected so that the communication quality of the connection of each terminal to the base station exceeds the predetermined value.

4. The centralized station according to claim 3, wherein
each base station includes:
power intensity detecting circuitry which detect intensity of power received from each of the terminals; and
an image sensor which photographs an object positioned between each terminal and the base terminal, and
the collecting circuitry is configured to
collect terminal position information and propagation loss information calculated based on the intensity of power detected by the power intensity detecting circuitry and the object photographed by the image sensor.

5. A wireless communication method in which a plurality of centralized stations coordinate and centrally control a plurality of base stations that can each accommodate a plurality of terminals, the wireless communication method comprising:
predicting traffic between each of the terminals and each of the base stations based on a relevance of each user using each of the terminals and selecting the base station to be connected based on the traffic of each of the terminals;
continuously collecting terminal position information indicating a position of each of the terminals and propagation loss information indicating propagation loss between each of the terminals and each of the base stations, respectively;
calculating a packet error rate of each of the base stations selected in the selecting based on each piece of the terminal position information and the propagation loss information continuously collected in the collecting;
determining, based on the packet error rate calculated in the calculating, a presence or absence of the terminal of which communication quality with respect to the base station is below a predetermined value; and
changing in which, when it is determined in the determining that there is the terminal of which communication quality with respect to the base station is below a predetermined value, the base station to which the terminal is to be connected is changed so that the communication quality of the connection of each terminal to the base station exceeds the predetermined value.

6. The wireless communication method according to claim 5, wherein
each base station includes:
power intensity detecting circuitry which detect intensity of power received from each of the terminals; and
an image sensor which photographs an object positioned between each terminal and the base terminal, and
in the collecting,
terminal position information and propagation loss information calculated based on the intensity of power detected by the power intensity detecting circuitry and the object photographed by the image sensor are collected.

7. A non-transitory computer-readable storage medium storing a centralized control program which causes a computer to function as each circuitry of the centralized station according to claim 3.
